(19) United States
(12) Patent Application Publication
(10) Pub. No.: US 2015/0131714 A1
(43) Pub. Date: May 14, 2015

(54) COMPRESSION/DECOMPRESSION PROGRESSIVE D'UN FLUX NUMERIQUE VIDEO COMPRENANT AU MOINS UNE IMAGE ENTRELACEE

(71) Applicant: ASSISTANCE TECHNIQUE ET ETUDE DE MATERIELS ELECTRONIQUES, Bièvres (FR)

(72) Inventor: Pierre Larbier, Bievres (FR)

(21) Appl. No.: 14/396,458

(22) PCT Filed: Apr. 22, 2013
(86) PCT No.: PCT/FR2013/050882

§ 371 Date: Oct. 23, 2014

(30) Foreign Application Priority Data
Apr. 23, 2012 (FR) 12 53717
Apr. 22, 2013 (FR) PCT/FR2013/050882

(51) Int. Cl. H04N 19/186; H04N 7/01

(52) U.S. Cl. CPC H04N 19/186; H04N 7/012
USPC 375/240.02

(57) ABSTRACT

The subject of the present invention pertains to a device (100) for decompressing a digital video stream comprising at least one compressed image (I′), said device comprising: —a means of progressive decompression (M4) configured so as to decode said at least one compressed image (I′), and —a means of inverse phase-shifting (M5) configured so as to horizontally and/or vertically phase shift the chrominance plane, for each field (tf, bf) of said at least one decompressed image (I′), according to a determined horizontal (dhi) and/or vertical (dvi) inverse phase shift value, said horizontal (dhi) and/or vertical (dvi) inverse phase shift value being dependent on the horizontal (dh) and/or vertical (dv) phase shift values.

### TECHNICAL FIELD

The object of the present invention relates to the field of compression/decompression of images, and more specifically the compression/decompression of digital video streams.

One aim of the invention is to allow compression/decompression of interlaced video sources with an encoder/decoder that only knows how to handle non-interlaced video sources.

The object of the present invention has particularly advantageous applications with the HEVC standard.

### PRIOR ART

Progressive scanning (also known as non-interlaced scanning) is a display mode used by electronic display systems. This display view is generally in contrast to interlaced (also known as interleaved) scanning.

The attached FIG. 1b is an example of a progressive image. This figure gives a more precise indication of the most common position of the chroma (chrominance, represented by “O”) and luma (luminance, represented by “X”) components in the case of the progressive 4:2:0 format (chroma components shared among 4 pixels).

As illustrated in FIG. 1a, a progressive image is composed of pixels arranged in rows.

In such an image, each pixel is represented by a luma component associated with two chroma components.

Due to the low sensitivity of the human eye to chroma components, they can be shared between several pixels; this is the case for example in the 4:2:0 format, where the chroma components are shared among four pixels.

The principle of progressive scanning is to display the entire image at once, as opposed to interlaced scanning where the odd rows of the image are displayed, followed by the even rows.

FIG. 1b shows an example of an interlaced image. This figure gives a more precise indication of the most common position of the chroma (chrominance, represented by “O”) and luma (luminance, represented by “X”) components in the case of the interlaced 4:2:0 format (chroma components shared between 4 pixels).

As shown here, the interlaced image consists of two separate fields: a first field or top field, and a second field or bottom field.

The first field consists of the even rows (0, 2, 4, 8, etc.), and the bottom field consists of the odd rows (1, 3, 5, 7, 9, etc.).

Comparing these two figures, one can see that in the case of an interlaced image (FIG. 1b), the relative position of the chroma and luma is different between the first field and the second field.

In contrast, the relative position of the chroma and luma is constant in the case of a progressive image (FIG. 1a).

Video compressors that natively handle interlaced formats contain computer means which can take into account the relative position of the luma and chroma.

However, encoders designed to compress only progressive video sources do not contain such means.

The applicant also notes that there is no technical solution for encoding interlaced images using an encoder for encoding progressive images.

Therefore, using a progressive encoder with interlaced video sources is currently not recommended.

Indeed, when using such an encoder, the fields of interlaced images supplied to the compressor are processed as that many progressive images.

In such case, because the position of chroma components can differ from one image (or field) to the next, the result is reduced coding efficiency (higher bit rate and/or lower quality) and visible coding artifacts in the chroma components.

Such usage is therefore strongly discouraged.

### OBJECT AND SUMMARY OF THE INVENTION

The invention aims to improve the situation described above, by addressing the disadvantages mentioned above.

One of the aims of the invention is to allow the encoding/decoding of an interlaced image by an encoder/decoder provided for progressive images.

For this purpose, the object of the invention relates to a method for compressing a digital video stream; this digital video stream comprises at least one image formed by interlacing at least first and second fields each containing at least one chroma plane and one luma plane.

Such an image is called an interlaced image.

As noted above, the relative position of the chroma and luma planes is different in the first field compared to the second field.

Advantageously, the compression method of the invention comprises a prior phase-shifting step.

During this step, for each field of said at least one image, the chroma plane is horizontally and/or vertically phase-shifted according to a determined horizontal and/or vertical phase shift value.

With such a phase shift, the relative position of the chroma and luma planes becomes constant.

Advantageously, the compression method of the invention comprises a progressive compression step which consists of encoding the successive fields of said at least one image.

With this sequence of technical steps, characteristic of the invention, the method enables the compression of at least one interlaced image using progressive compression.

In a variant embodiment of the invention, the digital video stream is in 4:2:0 format. In this embodiment, during the phase-shifting step, the chroma planes of the first field are phase-shifted vertically downward by n quarter-pixels, and the chroma planes of the second field are phase-shifted vertically upward by in quarter-pixels.

Here, n and in are positive integers between 1 and 3.

Advantageously, the compression method of the invention comprises a step of sending a signaling message containing at least some information concerning the horizontal and/or vertical phase shift value.

This message is particularly advantageous for decompression (such decompression is described below).

Advantageously, during the compression step, the successive fields of said at least one image are encoded according to the HEVC standard.

Correlatively, the object of the invention relates to a first computer program comprising instructions for executing the steps of the method as described above, particularly when said computer program is executed by a computer.

Such a computer program may use any programming language, and be in the form of source code, object code, or an intermediate code between source code and object code such as a partially compiled form, or any other desirable form.

Similarly, the object of the invention relates to a first computer-readable storage medium on which is stored a computer program comprising instructions for executing the steps of the method as described above.

The storage medium may be any entity or device capable of storing the program. For example, it may comprise a storage means such as ROM memory, for example a CD-ROM or a ROM microelectronic circuit, or a magnetic storage means, for example a diskette (floppy disk) or hard drive.

Or this storage medium may be a transmission medium such as an electrical or optical signal, such a signal possibly conveyed via an electrical or optical cable, by terrestrial or over-the-air radio, or by self-directed laser beam, or by other means. The computer program according to the invention may in particular be downloaded over a network such as the Internet.

Alternatively, the storage medium may be an integrated circuit in which the computer program is embedded, the integrated circuit being adapted to execute or be used in the execution of the method in question.

The object of the invention also relates to a compression device suitable for carrying out the steps described above.

Specifically, the compression device comprises computer means for compressing a digital video stream comprising at least one image formed by interlacing at least first and second fields; according to the invention, each of these fields contains at least one chroma plane and one luma plane, the relative position of the chroma and luma planes being different in the first field compared to the second field.

Advantageously, the compression device according to the invention comprises a phase-shifting means configured for phase-shifting the chroma plane horizontally and/or vertically, for each field of said at least one image.

This phase shift is done according to a determined horizontal and/or vertical phase shift value such that the relative position of the chroma and luma planes remains constant.

Advantageously, the compression device according to the invention comprises a progressive compression means which is configured to encode the successive fields of said at least one image.

In a variant embodiment of the invention, the digital video stream is in 4:2:0 format. In this embodiment, the phase-shifting means is configured such that the chroma planes of the first field are phase-shifted vertically downward by n quarter-pixels, and the chroma planes of the second field are phase-shifted vertically upward by in quarter-pixels.

Here, n and m are positive integers between 1 and 3.

Advantageously, the compression device of the invention comprises a transmission means configured to send a signaling message containing at least some information concerning the horizontal and/or vertical phase shift value.

Advantageously, the progressive compression means is configured to encode the successive fields of said at least one image according to the HEVC standard.

The object of the invention also relates to a method for decompressing a digital video stream comprising at least one image compressed according to the compression method described above.

Advantageously, the decompression method of the invention comprises a progressive decompression step consisting of decoding said at least one compressed image.

The decompression method according to the invention further comprises an inverse phase-shifting step during which, for each field of said at least one decompressed image, the chroma plane is phase-shifted horizontally and/or vertically according to a determined horizontal and/or vertical inverse phase shift value.

Preferably, the inverse horizontal and/or vertical phase shift value is dependent on the horizontal and/or vertical phase shift value.

In a variant embodiment of the invention, the digital video stream is in 4:2:0 format. In this embodiment, during the inverse phase-shifting step, the chroma planes of the first field are phase-shifted vertically upward by n quarter-pixels and the chroma planes of the second field are phase-shifted vertically downward by m quarter-pixels.

Here, n and in are positive integers between 1 and 3.

Advantageously, the decompression method according to the invention comprises a receiving step consisting of receiving a signaling message containing at least some information relating to the horizontal and/or vertical phase shift value.

Advantageously, the decompression method according to the invention comprises a determination step consisting of determining the horizontal and/or vertical inverse phase shift value as a function of the received horizontal and/or vertical phase shift value.

Preferably, during the progressive decompression step, the successive fields of said at least one image are decoded according to the HEVC standard.

Correlatively, the object of the invention relates to a second computer program comprising instructions for executing the steps of the decompression method as described above, when said computer program is executed by a computer.

Similarly, the object of the invention relates to a second computer-readable storage medium on which is stored a computer program comprising instructions for executing the steps of the decompression method as described above.

This second computer program and second storage medium have the same characteristics as those mentioned above for the first computer program and first storage medium respectively.

Alternatively, the object of the invention relates to a device for decompressing a digital video stream comprising at least one image compressed by the compression method described above.

Advantageously, the decompression device comprises a progressive decompression means configured for decoding said at least one compressed image.

Advantageously, the decompression device further comprises an inverse phase-shifting means configured for phase-shifting the chroma plane horizontally and/or vertically, for each field of said at least one decompressed image, according to a predetermined horizontal and/or vertical inverse phase shift value.

Preferably, the horizontal and/or vertical inverse phase shift value is dependent on the horizontal and/or vertical phase shift value.

In a variant embodiment of the invention, the digital video stream is in 4:2:0 format. In this embodiment, the inverse phase-shifting means is configured such that, for each field of said at least one decompressed image, the chroma planes of the first field are phase-shifted vertically downward by n quarter-pixels and the chroma planes of the second field are phase-shifted vertically upward by m quarter-pixels.

Here, n and m are positive integers between 1 and 3.

Advantageously, the decompression device comprises a receiving means configured for receiving a signaling message containing at least some information relating to the horizontal and/or vertical phase shift value.

Advantageously, the decompression device further comprises a determination means configured for determining the horizontal and/or vertical inverse phase shift value as a function of the received horizontal and/or vertical phase shift value.

Advantageously, the progressive decompression means is configured such that the successive fields of said at least one image are decoded according to the HEVC standard.

Thus, by means of its various functional and structural aspects, the object of the invention allows compressing/decompressing an interlaced image using an encoder/decoder adapted for progressive images.

### SHORT DESCRIPTION OF ATTACHED FIGURES

Other features and advantages of the invention will become apparent from the following description, with reference to the accompanying FIGS. 1a to 4 which illustrate an embodiment having no limiting character and in which:

FIGS. 1a and 1b each schematically show the most common position of the chroma and luma components in the case of the progressive 4:2:0 format and in the case of the interlaced 4:2:0 format,

FIG. 2 schematically represents a compression device according to an exemplary embodiment of the invention,

FIG. 3 schematically represents a decompression device according to an exemplary embodiment of the invention, and

FIG. 4 shows a flowchart illustrating the compression/decompression method according to an advantageous embodiment of the invention.

### DETAILED DESCRIPTION OF A PREFERRED EMBODIMENT OF THE INVENTION

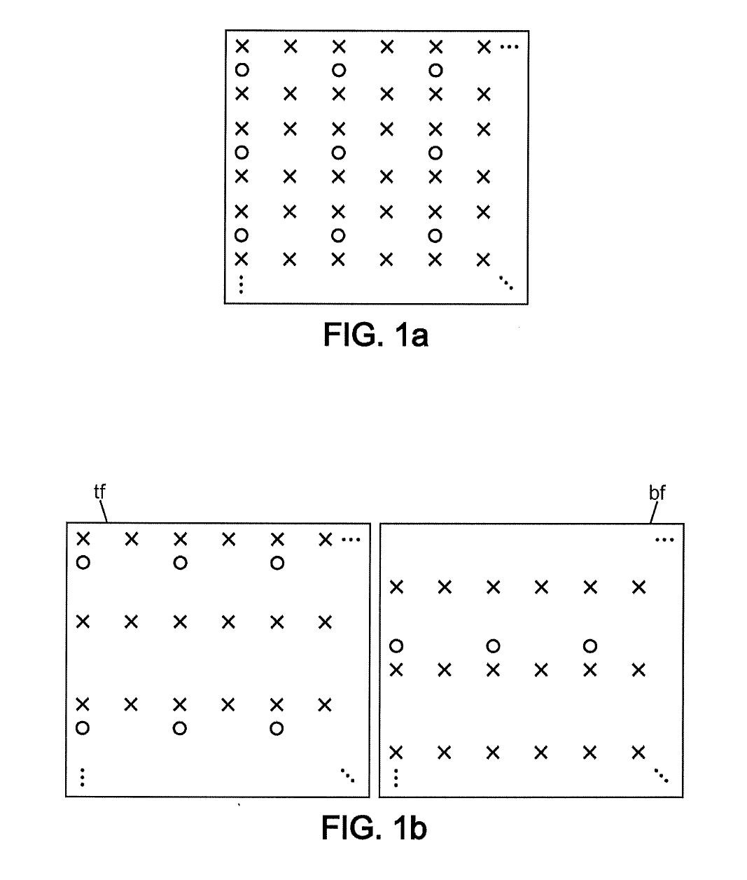

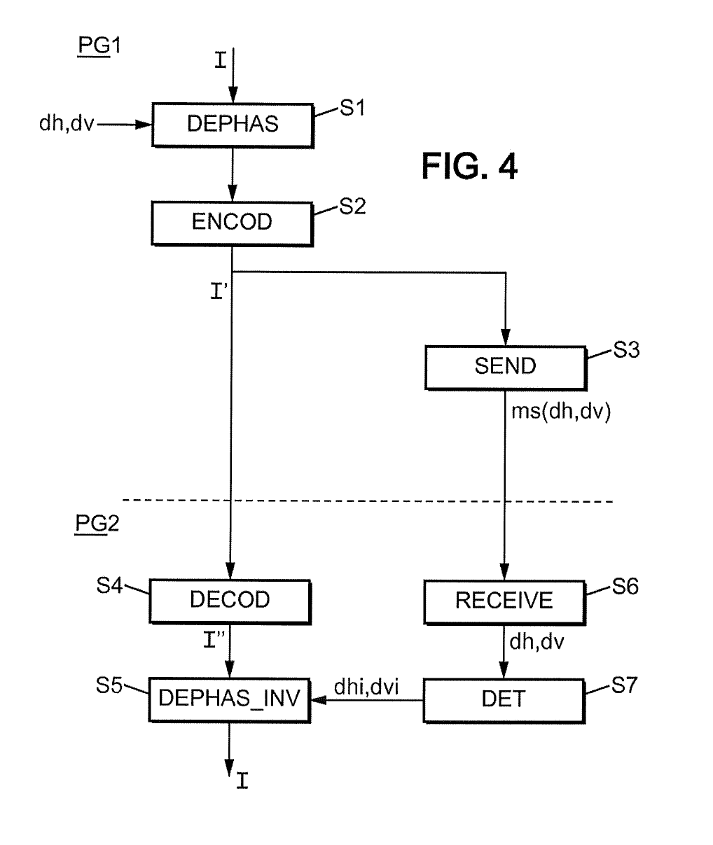

A compression/decompression method and a compression/decompression device in accordance with an advantageous embodiment of the invention will now be described with reference to FIGS. 1a to 4.

In the example described here, an interlaced image is an image formed by interlacing a first field (or top field) and a second field (or bottom field), each comprising two chroma planes and one luma plane.

The object of the invention is to allow compression/decompression of such an interlaced image using an encoder/decoder adapted for progressive images.

As mentioned above, examples of progressive and interlaced images in 4:2:0 format are respectively shown in FIGS. 1a and 1b. These figures give a more precise indication of the positions of the chroma and luma planes in such images:

In these FIGS. 1a and 1b, “X” represents the luma positions, and “O” represents the chroma positions.

As was observed above, for an interlaced image (FIG. 1b) the relative position of the luma and chroma is different in the first field tf (for “top field”) compared to the second field bf (for “bottom field”), which renders compression/decompression with a conventional encoder/decoder ineffective for progressive images.

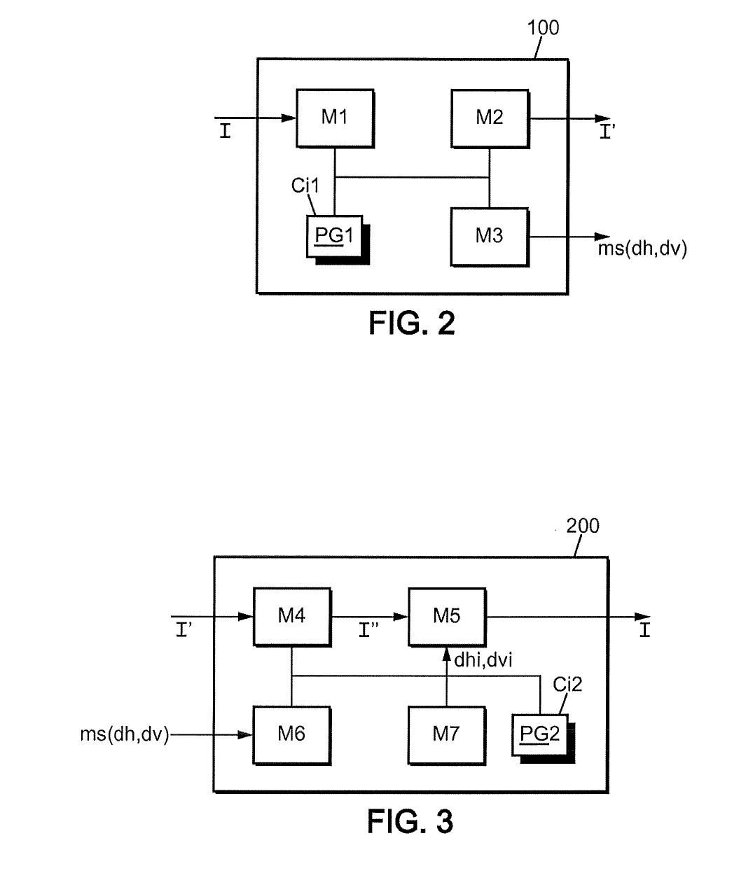

To solve this problem, the invention proposes a data compression device 100 as shown in FIG. 2 in which, prior to the actual compression, a phase-shifting means M1 is provided which is configured to phase shift vertically and horizontally the chroma plane for each field tf and bf of the image I, during a prior phase-shifting step S1.

This phase shift is done according to horizontal dh and vertical dv phase shift values that are determined such that the relative position of the chroma and luma planes remains constant as they do for a progressive image as illustrated in FIG. 1a.

In the example described here which refers to an image in 4:2:0 format, the two chroma planes of the first field tf are phase-shifted vertically downward by a quarter-pixel, and the chroma planes of the second field bf are phase-shifted vertically upward by a quarter-pixel.

In the example described here, after this phase shift, the computing device 100 comprises a progressive compression means M2 configured to encode the successive fields tf and bf of the image I in a progressive compression step S2, so as to obtain a compressed image I′.

Preferably, this compression is done according to the HEVC standard.

As shown in FIG. 2, in parallel with this compression, the computing device 100 comprises a transmitting means M3 which allows sending a signaling message with the compressed stream, which contains at least some information concerning the horizontal dh and vertical dv phase shift values.

Correlatively, as shown in FIG. 3, the invention provides a decompression computing device 200 which is adapted for decompressing the image I′.

To this end, the computing device 200 comprises a progressive decompression means M4 that is configured to decode the compressed image I′ and obtain an image I″.

This decompression means is initially provided for progressive images. It is understood that, by means of the invention, the computing device 200 adapts to decoding either progressive or interlaced images.

In the example described here, this decompression is done according to the HEVC standard.

In the example described here, the computing device 200 comprises a receiving means M6 configured for receiving, during a receiving step S6, the signaling message ms previously sent by the device 100.

The computing device 200 further comprises a determination means M7 configured for determining, during a determination step S7, the horizontal dhi and vertical dvi phase shift values according to the information contained in the signaling message ins.

In the example described here, the computing device 200 comprises an inverse phase-shifting means M5 configured for phase-shifting vertically and horizontally, during an inverse phase-shifting step S5, the chroma plane for each field tf and bf of the decompressed image I″.

This inverse phase-shifting is done according to the horizontal dhi and vertical dvi inverse phase shift values previously determined by the determination means M7.

In the example described here which relates to the 4:2:0 format, the two chroma planes of the first field tf are phase-shifted vertically upward by a quarter-pixel, and the chroma planes of the second field bf are phase-shifted vertically downward by a quarter-pixel.

Thus, with the present invention, the relative position of the chroma planes is moved before encoding in order to provide the video encoder with a constant and known relative position in all fields provided; and the chroma planes are returned after decoding to their original position in order to reconstruct the image I.

To allow repositioning after decoding, information concerning the phase shift accompanies the compressed stream. In the example described here, this information is conveyed by the signaling message ms which is an SEI message (for “Supplemental Enhancement Information”) carried in the compressed HEVC stream.

In the example described here, this SEI message is modified by adding the following fields in bold:

field_indication(payloadSize)

| | |
|---|---|
| { | sequence_type_flag |

progressive_source_flag
bottom_field_flag
top_field_first_flag)
duplicate_flag
chroma_{—}sample_{—}loc_{—}delta_{—}present_{—}flag
reserved_zero_2bits /* equal to 0 */

| if (chroma_sample_loc_delta _present_flag == 1 ) | |
|---|---|
| { | chroma_{—}sample_{—}loc_{—}vdelta |

chroma_{—}sample_{—}loc_{—}hdelta

}

}

The binary field “chroma_sample_loc_delta_present_flag”, when it is set to 1, indicates the presence of two additional fields “chroma_sample_loc_vdelta” and “chroma_sample_loc_hdelta”.

The fields “chroma_sample_loc_vdelta” and “chroma_sample_loc_hdelta” respectively represent the horizontal and vertical inverse phase shifts to be performed after decoding in order to restore the relative position of the chroma planes of the source image I.

These fields are expressed in signed quarter-pixel units, which enables a phase shift of +/−1, 2 or 3 quarter-pixels.

In the example described here, and as illustrated in FIGS. 2 and 3, it is understood that the various steps of the method for compression and decompression are respectively controlled by first PG1 and second PG2 computer programs contained on first CI1 and second CI storage media: medium CI1 being integrated into the compression computing device 100 and medium CI2 being integrated into the decompression computing device 200.

It should be noted that this detailed description relates to a particular embodiment of the invention, but in no case does this description assume any limitative character to the object of the invention; rather, it is intended to clarify any ambiguities or eliminate any misinterpretation of the following claims.

1. A method for compressing a digital video stream comprising at least one image formed by interlacing at least first and second fields each containing at least one chroma plane and one luma plane, the relative position of the chroma and luma planes being different in the first field compared to the second field,
wherein said method comprises the following steps:
a prior phase-shifting step during which, for each field of said at least one image, said at least one chroma plane is shifted horizontally and/or vertically phase-shifted according to a determined horizontal and/or vertical phase shift value in order to obtain a constant relative position of the chroma and luma planes, and
a progressive compression step consisting of encoding the successive fields of said at least one image.

2. The compression method according to claim 1, the digital video stream being in 4:2:0 format, wherein, during the phase-shifting step, the chroma planes of the first field are phase-shifted vertically downward by n quarter-pixels, n being a positive integer between 1 and 3, and the chroma planes of the second field are phase-shifted vertically upward by m quarter-pixels, m being a positive integer between 1 and 3.

3. The compression method according to claim 1, wherein it comprises a step of sending a signaling message containing at least some information concerning the horizontal and/or vertical phase shift values.

4. The compression method according to claim 1, wherein, during the compression step, the successive fields of said at least one image are encoded according to the HEVC standard.

5. A non-transmissible computer-readable storage medium comprising a computer program comprising instructions for executing the steps of the method according to claim 1 when said computer program is executed by a computer.

6. A device for compressing a digital video stream comprising at least one image formed by interlacing at least first and second fields each containing at least one chroma plane and one luma plane, the relative position of the chroma and luma planes being different in the first field compared to the second field,
wherein said device comprises:
a phase-shifting means configured for phase-shifting the chroma plane horizontally and/or vertically, for each field of said at least one image, according to a determined horizontal and/or vertical phase shift value such that the relative position of the chroma and luma planes remains constant, and
a progressive compression means configured to encode the successive fields of said at least one image.

7. The compression device according to claim 6, the video digital stream being in 4:2:0 format, wherein the phase-shifting means is configured such that the chroma planes of the first field are phase-shifted vertically downward by n quarter-pixels, n being a positive integer between 1 and 3, and the chroma planes of the second field are phase-shifted vertically upward by m quarter-pixels, m being a positive integer between 1 and 3.

8. The compression device according to claim 6, wherein it comprises a transmission means configured to send a signaling message containing at least some information concerning the horizontal and/or vertical phase shift values.

9. The compression device according to claim 6, wherein the progressive compression means is configured to encode the successive fields of said at least one image according to the HEVC standard.

10. A method for decompressing a digital video stream comprising at least one image compressed according to claim 1,
wherein said method comprises the following steps:
a progressive decompression step consisting of decoding said at least one compressed image, and
an inverse phase-shifting step during which, for each field of said at least one decompressed image, the chroma plane is phase-shifted horizontally and/or vertically according to a determined horizontal and/or vertical inverse phase shift value, said horizontal and/or vertical inverse phase shift value being dependent on the horizontal and/or vertical phase shift value.

11. The decompression method according to claim 10, the video digital stream being in 4:2:0 format, wherein, during the inverse phase-shifting step, the chroma planes of the first field are phase-shifted vertically upward by n quarter-pixels, n being a positive integer between 1 and 3, and the chroma planes of the second field are phase-shifted vertically downward by m quarter-pixels, m being a positive integer between 1 and 3.

12. The decompression method according to claim 10, wherein it comprises a receiving step consisting of receiving a signaling message containing at least some information relating to the horizontal and/or vertical phase shift values, and wherein it comprises a determination step consisting of determining the horizontal and/or vertical inverse phase shift value as a function of the received horizontal and/or vertical phase shift value.

13. The decompression method according to claim 10, wherein, during the progressive decompression step, the successive fields of said at least one compressed image are decoded according to the HEVC standard.

14. A non-transmissible computer-readable storage medium comprising a computer program comprising instructions for executing the steps of the method according to claim 1, when said computer program is executed by a computer.

15. A device for decompressing a digital video stream comprising at least one image compressed according to claim 1,
wherein said device comprises:
a progressive decompression means configured for decoding said at least one compressed image, and
an inverse phase-shifting means configured for phase-shifting the chroma plane horizontally and/or vertically, for each field of said at least one decompressed image, according to a predetermined horizontal and/or vertical inverse phase shift value, said horizontal and/or vertical inverse phase shift value being dependent on the horizontal and/or vertical phase shift value.

16. The decompression device according to claim 15, the video digital stream being in 4:2:0 format, wherein the inverse phase-shifting means is configured such that, for each field of said at least one decompressed image, the chroma planes of the first field are phase-shifted vertically downward by n quarter-pixels, n being a positive integer between 1 and 3, and the chroma planes of the second field are phase-shifted vertically upward by m quarter-pixels, m being a positive integer between 1 and 3.

17. The decompression device according to claim 15, wherein it comprises a receiving means configured for receiving a signaling message containing at least some information relating to the horizontal and/or vertical phase shift values, and wherein it comprises a determination means configured for determining the horizontal and/or vertical inverse phase shift values as a function of the received horizontal and/or vertical phase shift value.

18. The decompression device according to claim 15, wherein the progressive decompression means is configured such that the successive fields of said at least one compressed image are decoded according to the HEVC standard.
